(19) United States
(12) Patent Application Publication
(10) Pub. No.: US 2008/0043377 A1
(43) Pub. Date: Feb. 21, 2008

(54) Magnetic head

(75) Inventors: Shigeru Yoshiike, Kawasaki (JP); Hirofumi Nagai, Kawasaki (JP); Motonori Ueda, Kawasaki (JP)

Correspondence Address: Patrick G. Burns;GREER, BURNS & CRAIN, LTD., Suite 2500, 300 South Wacker Drive, Chicago, IL, 60606, US

(73) Assignee: FUJITSU LIMITED

(21) Appl. No.: 11/641,616

(22) Filed: Dec. 18, 2006

(30) Foreign Application Priority Data
Jun. 26, 2006 (JP) 2006-175882

(51) Int. Cl. G11B 5/33

(52) U.S. Cl. 360/319

(57) ABSTRACT

The magnetic head is capable of stabilizing arrangement of magnetic domains in a shield layer of a read-head, preventing variation of characteristics of the read-element and improving reliability. The magnetic head comprises the read-head, in which the read-element is magnetic-shielded by a shield layer. A step-shaped section is formed in a base layer, on which the shield layer is formed, and the step-shaped section corresponds to a border of at least one of domain areas, which are defined by desired magnetic domains to be formed in the shield layer after a magnetizing process.

### BACKGROUND OF THE INVENTION

The present invention relates to a magnetic head, more precisely relates to a magnetic head, which is characterized by a shield layer of a read-head.

FIG. 10 shows a positional relationship between a recording medium 5 and a read-head of a magnetic head reading data from the recording medium 5. In the read-head, a read-element 10 is sandwiched between a lower shield layer 12 and an upper shield layer 14, which are magnetic layers. The lower shield layer 12 and the upper shield layer 14 shield the read-element 10 so as to prevent magnetic fields of bits other than an object bit from working to the read-element 10. The lower shield layer 12 and the upper shield layer 14 are made of a soft magnetic material and usually formed into rectangular shapes by electrolytic plating.

The read-element 10 includes a hard film, which orientates magnetization directions of a free layer. In a production process of the magnetic head, a strong magnetic field is applied to the magnetic head, as a magnetizing process, so as to orientate magnetization directions of the hard film. By applying the strong magnetic field, the lower shield layer 12 and the upper shield layer 14, which are soft magnetic layers, respectively have single magnetic domains. Further, they have domain arrangements shown in FIGS. 11A-11C after completing the magnetizing process.

The domain arrangements shown in FIGS. 11A-11C are called reflux domain structures, in each of which the shield layers are capable of effectively shielding. FIGS. 11A and 11B show examples of four-domain structures; FIG. 11C shows an example of a seven-domain structure. In the examples, the magnetic heads have enough magnetic shielding properties. In case of the four-domain structures, the lower shield layer 12 and the upper shield layer 14 are formed into rectangular shapes, so the clockwise domain structure shown in FIG. 11A and the counterclockwise domain structure shown in FIG. 11B are formed with the same probabilities.

In the domain structures shown in FIGS. 11A-11C, the shielding functions work effectively. The read-element 10 is easily influenced by leakage magnetic fields from the lower shield layer 12 and the upper shield layer 14, and the leakage magnetic fields from the shield layers are easily generated at magnetic walls of the magnetic domains. As shown in FIGS. 11A-11C, the read-element 10 is separated from the magnetic walls, so the read-element 10 can be protected from influences of the leakage magnetic fields even if the magnetic walls are moved. Therefore, the magnetic domain structures shown in FIGS. 11A-11C are effective. When the magnetic head is produced, thickness, shapes and composition of the shield layers are adjusted so as to form the reflux domain structures without forming “longitudinally arranged magnetic domains”, in which magnetic domains are arranged in the longitudinal direction by a magnetizing process.

In the process of producing the magnetic head, the shield layers are formed to have the stable reflux magnetic domain structures. However, shapes of the magnetic domains are changed by magnetic fields from a recording medium, leakage magnetic fields from a write-head of the magnetic head, external magnetic fields working to the magnetic head, stress caused by heat of a recording coil, etc., so that characteristics of the read-element are varied. By changing the shapes of the magnetic domains of the shield layers, the magnetic walls is moved close to the read-element, so that leakage magnetic fields from the magnetic walls badly influence the read-element as magnetic noises.

Further, as described above, the magnetizing field is disappeared so as to orientate the magnetization directions of the hard film. In case of the four-domain structure, the clockwise domain structure and the counterclockwise domain structure are formed with the same probabilities. The magnetization direction of the magnetic domain, which corresponds to the read-element, in the clockwise domain structure is opposite to that in the counterclockwise domain structure. Therefore, output signals and characteristics of the read-element are varied.

| | |
|---|---|
| Patent Document 1 | Japanese Patent Gazette No. 2004-501478 |
| Patent Document 2 | Japanese Patent Gazette No. 11-31306 |
| Patent Document 3 | Japanese Patent Gazette No. 2002-50009 |

### SUMMARY OF THE INVENTION

The present invention was conceived to solve the problems.

An object of the present invention is to provide a magnetic head, which is capable of stabilizing arrangement of magnetic domains in a shield layer of a read-head, preventing variation of characteristics of the read-element and improving reliability.

To achieve the object, the present invention has following structures.

Namely, the magnetic head of the present invention comprises a read-head, in which a read-element is magnetic-shielded by a shield layer, a step-shaped section is formed in a base layer, on which the shield layer is formed, and the step-shaped section corresponds to a border of at least one of domain areas, which are defined by desired magnetic domains to be formed in the shield layer after a magnetizing process.

In the magnetic head, a height of the domain area sectionalized by the step-shaped section may be lower than that of other domain areas, and the height of the domain area sectionalized by the step-shaped section may be higher than that of other domain areas. With these structures, the magnetic domains can be desirably arranged in the shield layer, which has been magnetized.

In the magnetic head, a step pattern, which is separately formed from the base layer, may be formed in the domain area sectionalized by the step-shaped section, and a height of the step pattern may be lower than that of other domain areas. Further, the step pattern, which is separately formed from the base layer, may be formed in the domain area sectionalized by the step-shaped section, and the height of the step pattern may be higher than that of other domain areas. With these structures too, the magnetic domains can be desirably arranged in the shield layer, which has been magnetized.

Another magnetic head comprises a read-head, in which a read-element is magnetic-shielded by a shield layer, a step-shaped slit is formed in a base layer, on which the shield layer is formed, and the step-shaped slit corresponds to a border of at least one of domain areas, which are defined by desired magnetic domains to be formed in the shield layer after a magnetizing process.

Further, another magnetic head comprises a read-head, in which a read-element is magnetic-shielded by a shield layer, a step-shaped slit is formed in a surface of the shield layer, and corresponds to a border of at least one of domain areas, which are defined by desired magnetic domains to be formed in the shield layer after a magnetizing process.

In the magnetic head, a height of the domain area sectionalized by the step-shaped section may be lower than that of other domain areas, and the height of the domain area sectionalized by the step-shaped section may be higher than that of other domain areas. With these structures, the magnetic domains can be desirably arranged in the shield layer, which has been magnetized.

Further, in each of the magnetic heads, the magnetic domains generated in the shield layer may be asymmetrically arranged with respect to a height direction of the shield layer, and area of the magnetic domain overlapping the read-element may be maximized. With this structure, a magnetic wall of the shield layer never interferes with the read-element, so that reliability of the read-element can be improved. In the magnetizing process, the magnetizing direction becomes a magnetization direction of the magnetic domain, which is flush with the read-element, so that variation of output signals of the read-element can be restrained.

In the magnetic head of the present invention, the step-shaped section is formed in the base layer of the shield layer or the surface of the shield layer. Therefore, when the magnetic domains are formed in the shield layer after completing the magnetizing process, a magnetic wall is induced by the step-shaped section, so that the magnetic domains of the shield layer can be desirably arranged. With this structure, the domain arrangement of the shield layer can be stabilized, and reliability of the magnetic head can be improved.

### BRIEF DESCRIPTION OF THE DRAWINGS

Embodiments of the present invention will now be described by way of examples and with reference to the accompanying drawings, in which:

FIG. 1A is a plan view of a base layer of a magnetic head of a first embodiment;

FIG. 1B is a sectional view taken along a line A-A shown in FIG. 1A;

FIG. 1C is a plan view of a shield layer of the magnetic head;

FIG. 2A is a plan view of an example of a step-shaped section formed in the base layer;

FIG. 2B is a sectional view taken along a line A-A shown in FIG. 2A;

FIG. 3A is a plan view of another example of the step-shaped section formed in the base layer;

FIG. 3B is a sectional view taken along a line A-A shown in FIG. 3A;

FIGS. 4A and 4B are plan views of shield layers having seven-domain structures, in each of which the step-shaped section is formed in the base layer;

FIG. 5A is a plan view of an example of a step pattern formed in the base layer of a second embodiment;

FIG. 5B is a sectional view taken along a line A-A shown in FIG. 5A;

FIG. 5C is a plan view of another example of the step pattern;

FIG. 5D is a sectional view taken along a line B-B shown in FIG. 5C;

FIG. 6A is a plan view of an example of a step-shaped slit formed in the base layer of a third embodiment;

FIG. 6B is a sectional view taken along a line A-A shown in FIG. 6A;

FIG. 6C is a plan view of another example of the step-shaped slit;

FIG. 7A is a plan view of an example of a step pattern formed in the base layer of a fourth embodiment;

FIG. 7B is a sectional view taken along a line A-A shown in FIG. 7A;

FIG. 7C is a plan view of another example of the step pattern;

FIG. 7D is an explanation view showing arrangement of magnetic domains;

FIGS. 8A-8C are plan views of examples of step-shaped sections formed in the base layer, etc. of a fifth embodiment;

FIG. 9A is an explanation view of a domain structure of the shield, in which a magnetizing field is applied;

FIG. 9B is an explanation view of the domain structure of the shield, in which the magnetizing field is disappeared;

FIG. 10 is an explanation view showing the positional relationship between the recording medium and the read-element; and

FIG. 11 is an explanation view showing the magnetic domain arrangement of the shield layer.

### DETAILED DESCRIPTION OF THE EMBODIMENTS

Preferred embodiments of the present invention will now be described in detail with reference to the accompanying drawings.

### First Embodiment

A first embodiment is characterized in that step-shaped sections are formed in base layers of shield layers (a lower shield layer and an upper shield layer) of a read-head, the sep-shaped sections are provided to, and the shield layers are respectively formed on the base layers having the step-shaped sections so as to stabilize magnetic domain structures of the shield layers.

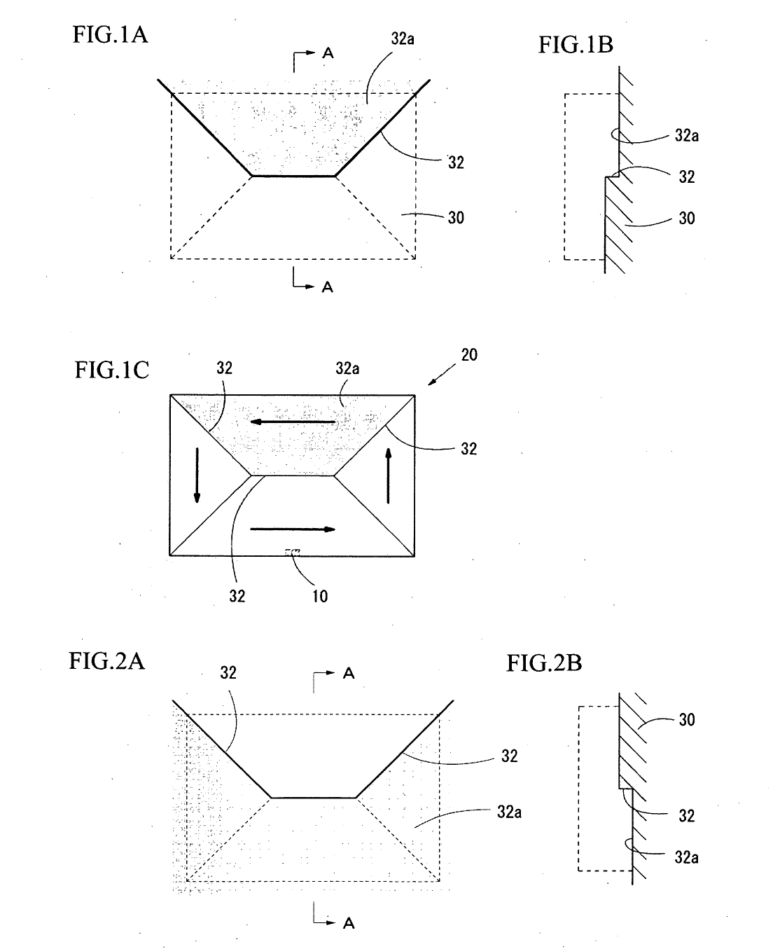

FIG. 1A is a plan view of a base layer, and FIG. 1B is a sectional view taken along a line A-A shown in FIG. 1A. In FIGS. 1A and 1B, a reflux four-domain structure is formed after a magnetizing process. A step-shaped section 32 is formed in a base layer 30 along edges or borders of a trapezoidal domain area, and a surface of the trapezoidal domain area is a step face 32a. The trapezoidal domain area having the step face 32a is provided on the opposite side of the other trapezoidal domain area, which will correspond to a read-element.

FIG. 1C is a plan view of a shield layer 20, in which a magnetic layer is formed on the base layer 30 by electrolytic plating, and its magnetic domain structure, which is formed after completing the magnetizing process. The magnetic layer is formed on the base layer 30 with forming the step-shaped section 32, so that magnetic domains are arranged to form a magnetic wall along the step-shaped section 32. Therefore, the reflux domain structure shown in FIG. 1C can be formed.

In a magnetic film, a position of a magnetic wall is shifted by defects in the film, it is difficult for the magnetic wall to get over the step-shaped section when the magnetic wall moves, and the magnetic wall is induced along the step-shaped section. Therefore, such magnetic domain structure is formed. By using the characteristics of the magnetic film, the step-shaped section is formed in the magnetic film on the basis of the desirable domain structure to be realized in the shield layer 20, so that the desirable domain structure can be formed in the shield layer 20.

In FIGS. 2A and 2B, the step-shaped section 32 is formed on the base layer 30 as well as the example shown in FIGS. 1A-1C, but the step face 32a is formed on the opposite side of the step face 32a shown in FIG. 1A. The step-shaped section 32 formed on the base layer 30 may be designed on the basis of the desirable domain structure to be realized in the shield layer 20, so the step face 32a may be formed on either side.

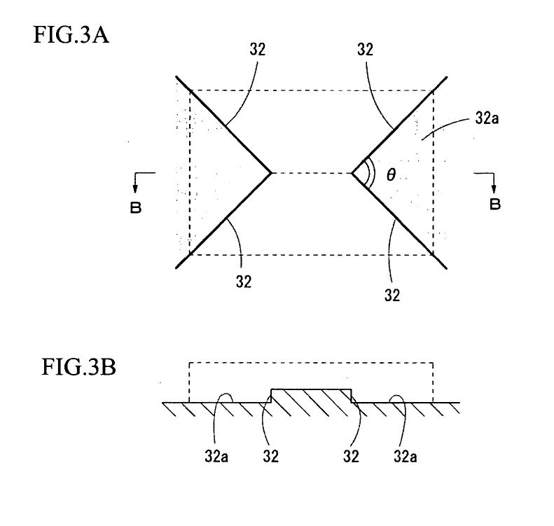

In FIGS. 3A and 3B, the step-shaped sections are formed on the base layer 30 along edges of two triangular domains of the four-domain structure. FIG. 3B is a sectional view taken along a line A-A shown in FIG. 3A. The base layer 30 is formed so as to form the step faces 32a in triangular domain areas for the four-domain structure, then the shield layer is formed, so that the reflux four-domain structure can be formed. The step face 32a of the base layer 30 corresponds to at least one domain area so as to form the reflux domain structure of the shield layer.

In the example shown in FIGS. 3A and 3B, the step faces 32a are formed in the right and left triangular domain areas, but one step face 32a may be formed in one of the triangular domain areas for forming the reflux four-domain structure. Note that, if angles θ of the triangular domain areas are 90 degrees, the stable reflux four-domain structure can be formed.

For example, the step-shaped section 30 and the step face 32a are formed in a lower shield layer 12 by the steps of: forming a resist pattern on a substrate, which becomes the base layer 30, with exposing a part of a surface thereof, in which the step face 32a will be formed; and cutting the part, in which the step face 32a of the base layer 30 will be formed, by ion milling.

On the other hand, the step-shaped section 30 and the step face 32a are formed in an upper shield layer 14 by the steps of: forming a resist pattern on an insulating layer, which is made of, for example, alumina and which is formed under the upper shield layer 14, with exposing a part of a surface thereof, in which the step face 32a will be formed; and forming the step face 32a by ion milling.

Thickness of the lower shield layer 12 and the upper shield layer 14 are several μm. Height of the step-shaped section 32 is equal to or less than the thickness.

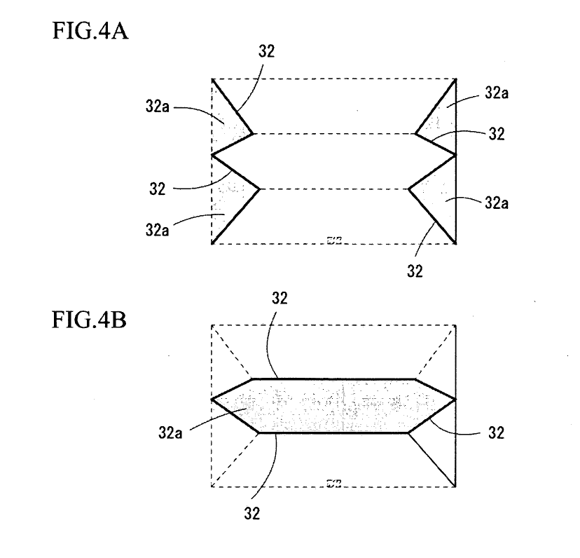

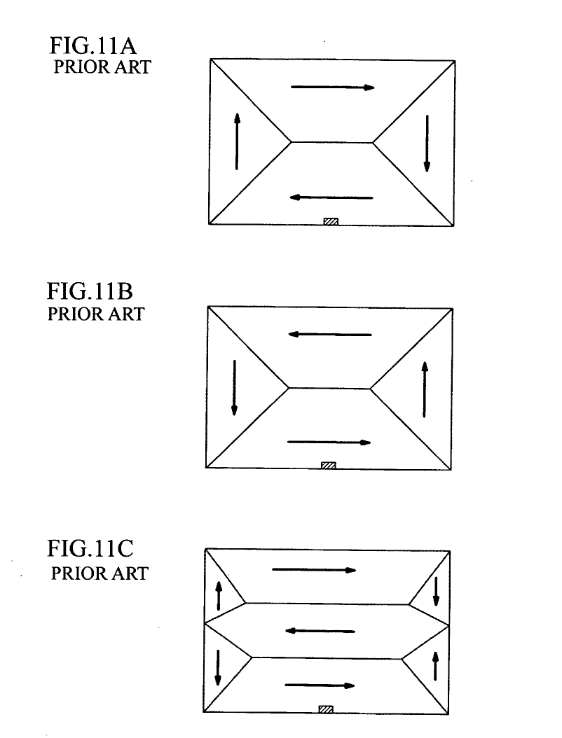

In the first embodiment, the shield layers have the four-domain structures. The example shown in FIGS. 4A and 4B has a reflux seven-domain structure as well as the example shown in FIG. 11 C.

In FIG. 4A, the step sections 32 are formed along edges of triangular domain areas, which are formed in both longitudinal end parts of the shield layer having the seven-domain structure.

In FIG. 4B, the step-shaped section 32 is formed along edges of a hexagonal domain area, which is the central area of the seven-domain structure, and the surface of the hexagonal domain area is the step face 32a.

In this example too, magnetic walls of the magnetic domains, which are generated when a magnetizing field is disappeared, is introduced to the position of the step-shaped section 32, so that the reflux seven-domain structure shown in FIG. 11C can be realized.

By forming the shield layer 20 into the reflux four- or seven-domain structure, a shielding property of the shield layer 20 can be improved, the magnetic domains can be stabilized, variation of characteristics of the magnetic head can be prevented, and the characteristics of the magnetic head can be stabilized.

### Second Embodiment

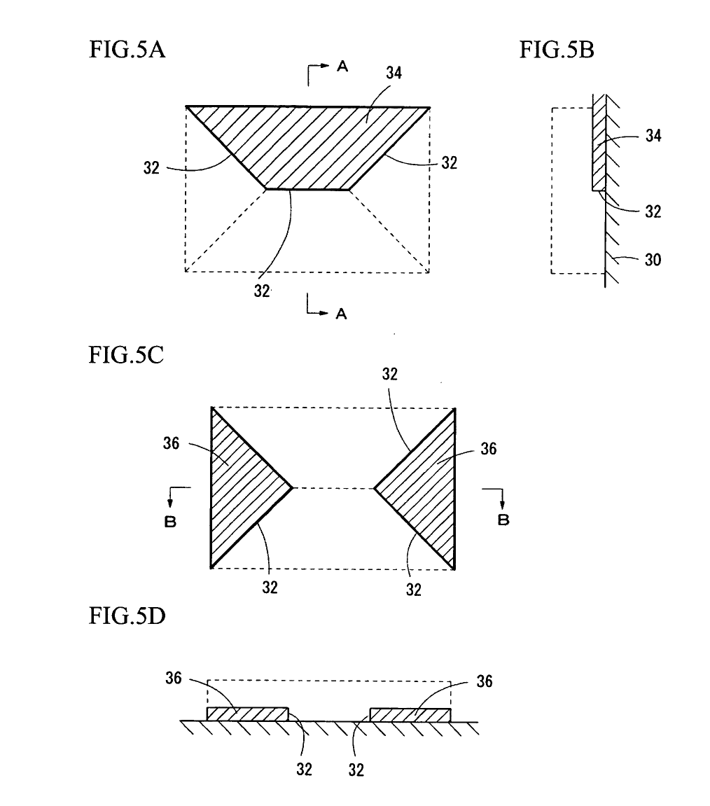

The magnetic head of a second embodiment is shown in FIGS. 5A-5D. Note that, structural elements explained in the first embodiment are assigned to the same symbols and explanation will be omitted.

In case of forming the step-shaped section or sections in the base layer so as to form the reflux domain structure in the shield layer, a height of the step face may be lower or higher than that of surfaces of other domain areas.

In the first embodiment, the step-shaped section 32 and the step face 32a are formed in the base layer 30 by ion milling. In the present embodiment, the step-shaped section 32 is formed by separately forming a step pattern, which is formed for forming the step-shaped section 32, from the base layer 30.

Examples of the present embodiment are shown in FIGS. 5A-5D. The step patterns 34 and 36, which are metal layers, are separately formed on the base layers 30. In FIG. 5A, the step pattern 34 is formed in the trapezoidal domain area of the four-domain structure. FIG. 5B is a sectional view taken along a line A-A shown in FIG. 5A. On the other hand, in FIG. 5C, the step patterns 34 are respectively formed in the triangular domain areas of the four-domain structure. FIG. 5D is a sectional view taken along a line B-B shown in FIG. 5C.

In each of the examples, edges of the step patterns 34 and 36 correspond to edges or borders of the magnetic domains of the shield layers.

The step patterns 34 and 36 are formed by the steps of: forming a metal layer on the surfaces of the base layer 30 by, for example, sputtering or plating; and etching the metal layer with using a resist pattern as an etching mask. In another case, an insulating layer having a prescribed pattern may be formed instead of the metal layer.

Note that, in FIGS. 5A and 5C, the step patterns may be formed in domain areas other than the hatched domain areas when the step patterns are formed in the base layers. In this case too, edges of the step patterns correspond to edges or borders of the domain areas.

### Third Embodiment

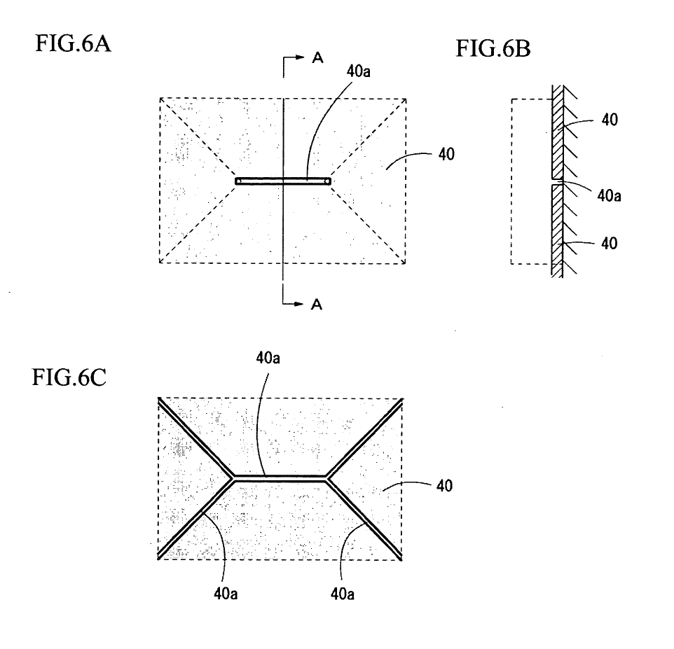

The magnetic head of a third embodiment is shown in FIGS. 6A-6C. Note that, structural elements explained in the foregoing embodiment are assigned to the same symbols and explanation will be omitted.

In the third embodiment, the shield layer has the reflux four-domain structure. This structure is formed by forming step-shaped slits 40a, which correspond to edges or borders of magnetic domains constituting the reflux magnetic domain structure, in a base layer 40, on which the shield layer will be formed. In the present embodiment, the base layer 40 is a metal film layer formed on a substrate.

In FIG. 6A, the step-shaped slit 40a is formed in the base layer 40 along a central border between the trapezoidal domain areas of the four-domain structure. FIG. 6B is a sectional view taken along a line A-A shown in FIG. 6A. Further, in FIG. 6C, the step-shaped slits 40a are formed in the base layer 40 along borders sectionalizing the magnetic domains of the four-domain structure.

By forming the step-shaped slit 40a, which corresponds to the border of the magnetic domains to be formed in the shield layer, in the base layer 40 of the shield layer, the shield layer is formed into a thin projection in a part, in which the step-shaped slit 40a is formed, when the shield layer is formed on a surface of the base layer 40. The magnetic wall is introduced to the position of the part, in which the step-shaped slit 40a is formed, when the magnetic domains are formed in the shield layer by the magnetizing process. Therefore, the desirable reflux domain structure can be formed.

### Fourth Embodiment

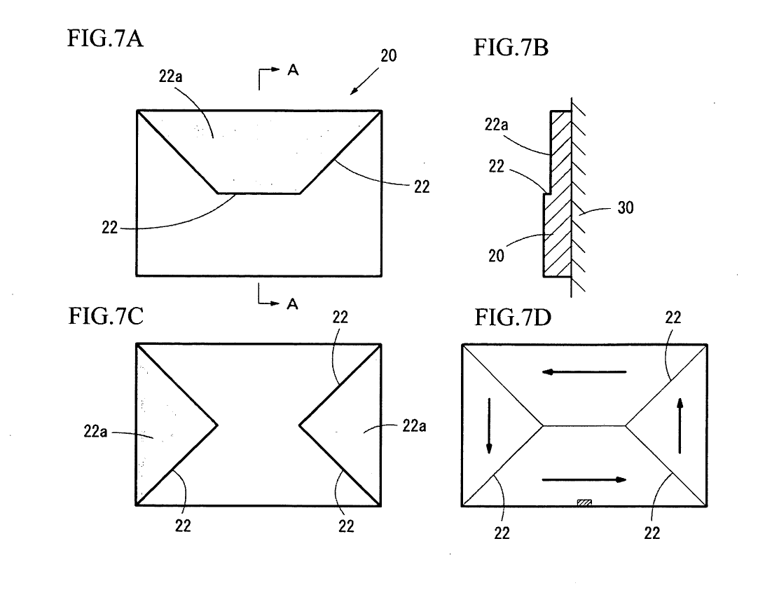

The magnetic head of a fourth embodiment is shown in FIGS. 7A-7D. Note that, structural elements explained in the foregoing embodiment are assigned to the same symbols and explanation will be omitted.

In the above described embodiments, the step-shaped sections 32 and the step-shaped slits 40a are formed in the base layers of the shield layers so as to form the reflux domain structures in the shield layers. In the present embodiment, a desirable magnetic domain structure is formed by the steps of: forming the shield layer 20 having a prescribed planar pattern, e.g., rectangular pattern, on the surface of the base layer; forming step-shaped sections 22 on the surface of the shield layer 20; and performing the magnetizing process.

In FIG. 7A, the step-shaped sections 22 are formed along edges or borders of a trapezoidal magnetic domain, which is included in the four-domain structure, so as to form a step face 22a in the surface of the shield layer 20. In FIG. 7C, the step-shaped sections 22 are formed along edges or borders of triangular magnetic domains, which are included in the four-domain structure, so as to form step faces 22a in the surface of the shield layer 20. Note that, FIG. 6B is a sectional view taken along a line A-A shown in FIG. 6A, and FIG. 6D is a sectional view taken along a line B-B shown in FIG. 6C.

The step face 22a is formed by the steps of: forming the shield layer 20; coating the shield layer 20 with resist with exposing a part of a surface thereof, in which the step face 22a will be formed; and cutting the shield layer 20 by ion milling.

By forming the step-shaped sections 22 in the surface of the shield layer 20, magnetic walls is introduced to the positions of the step-shaped sections 22, so that the reflux four-domain structure can be formed in the shield layer 20 when the magnetizing process is performed. As shown in FIG. 7D, the four-domain structure is formed in the shield layer 20 according to the positions of the step-shaped sections 22.

In the present embodiment, the step faces 22a are lower than surfaces of other domain areas, but the step faces 22a may be made higher than the surfaces of other domain areas by cutting the surfaces of other domain areas by ion milling.

Further, narrow grooves may be formed in the shield layer 20 along the borders of the magnetic domains instead of forming the step-shaped sections 22 in the shield layer 20. In this case too, the positions of the magnetic walls are introduced to the grooves, and the desirable four-domain structure can be formed in the shield layer 20.

### Fifth Embodiment

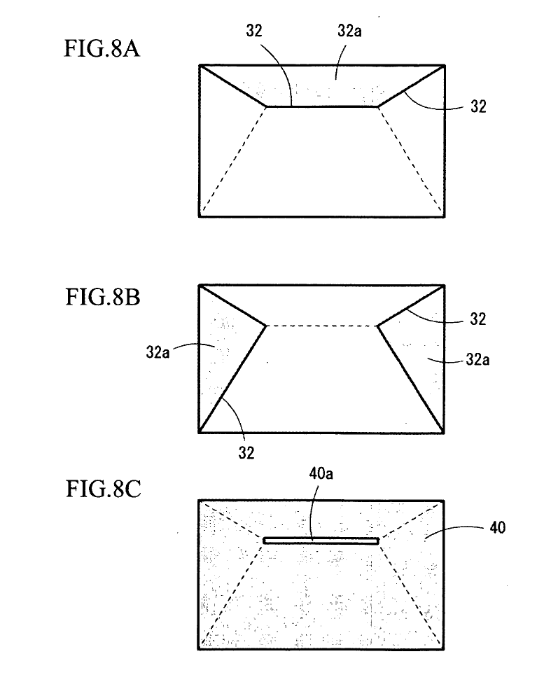

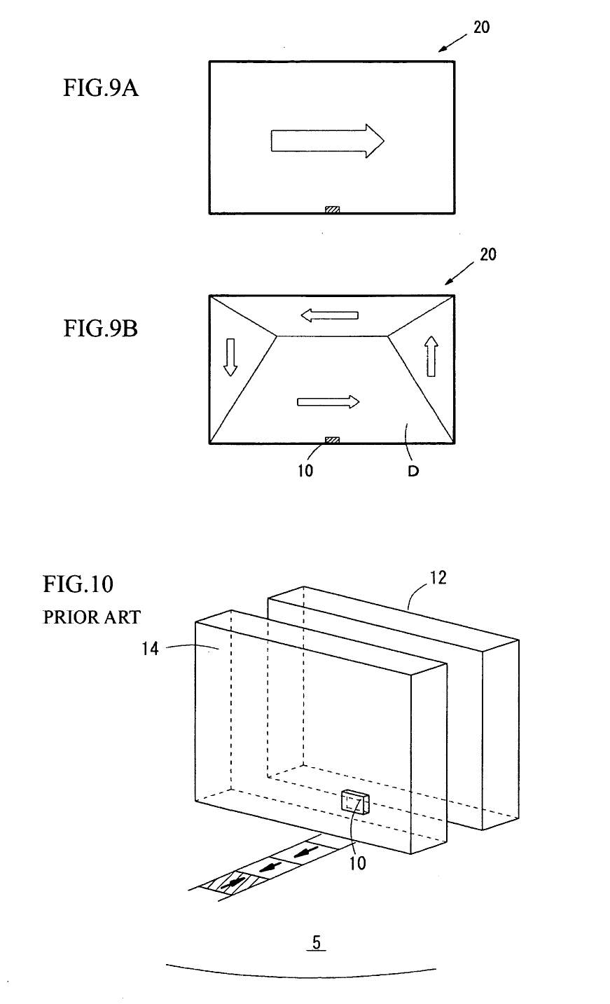

The magnetic head of a fifth embodiment is shown in FIGS. 8A-9B. Note that, structural elements explained in the foregoing embodiment are assigned to the same symbols and explanation will be omitted.

As described above, the desirable magnetic domain structure can be formed in the shield layer by forming the step-shaped sections, etc. in the shield layer or the base layer of the shield layer. The magnetic domains are usually symmetrically arranged in the height direction (vertical direction). Further, the magnetic domains can be asymmetrically arranged in the height direction.

FIGS. 8A-8C show reflux four-domain structures, in each of which the magnetic domains are asymmetrically arranged in the vertical direction. In FIG. 8A, the border between trapezoidal magnetic domains is upwardly shifted, and a step-shaped section 32 is formed along the border; in FIG. 8B, apexes of triangular step faces are upwardly shifted; in FIG. 8C, the position of the step-shaped slit 40a, which is formed in the base layer 40, is upwardly shifted in the height direction. The positions of the magnetic domains of the shield layer can be controlled by the methods of the present embodiment and the foregoing embodiments.

By setting the positions of the step-shaped sections 32 or the step-shaped slit 40a as described above, an arrangement of the magnetic domains in the shield layer 20 is induced by the step-shaped sections 32 or the step-shaped slit 40a after the magnetizing process, so that the reflux domain structure, in which the magnetic domains are asymmetrically arranged in the vertical direction, can be formed.

FIGS. 9A and 9B show the magnetic domains of the shield layer 20 during the magnetizing process. In FIG. 9A, a single magnetic domain is formed in the shield layer 20 by a strong magnetizing field; in FIG. 9B, the strong magnetizing field is disappeared, and the magnetic domain arrangement and magnetization directions of the magnetic domains are shown.

If the magnetic domains of the shield layer 20 are asymmetrically arranged in the height direction as described above, the magnetization directions of the magnetic domains are the same as that of the broadest trapezoidal domain area D after completing the magnetizing process. In the conventional shield layer, the magnetic domains are symmetrically arranged in the height direction, so that the clockwise domain structure and the counterclockwise domain structure are formed in the shield layer, after completing the magnetizing process, with the same probabilities. On the other hand, in the present embodiment, the magnetic domains are asymmetrically arranged in the shield layer 20, so the magnetization directions of the magnetic domains can be securely defined after disappearing the magnetizing field. In FIG. 9A, the magnetizing field is applied rightward; if the magnetizing field is applied leftward, the domain area D is magnetized in the direction opposite to that shown in FIG. 9B.

By defining the magnetization direction of the magnetic domains formed in the shield layer 20, a magnetic force in a prescribed direction is applied to the read-element 10 even if a leakage magnetic field from the shield layer 20 is applied to the read-element 10. Therefore, a problem of varying output signals of the read-element 10, which is caused by changing the direction of the leakage magnetic field, can be solved. If the read-element 10 is highly sensitive to the leakage magnetic field, it is very effective to control the magnetization directions of the magnetic domains in one direction so that characteristics of the magnetic head can be improved.

In case of arranging the read-element 10 in the broadest trapezoidal domain area D as shown in FIG. 9B, the read-element 10 is wide apart from the magnetic wall of the shield layer 20. The read-element 10 is less influenced by the magnetic wall even if the magnetic wall of the shield layer 20 is moved by external factors, so that the magnetic head having stable characteristics can be realized.

The lower shield layer 12 and the upper shield layer 14 have the rectangular planar shapes, but they may have other planer shapes, e.g., trapezoidal shapes, hexagonal shapes. In the present invention, the desirable magnetic domain structure can be formed in the shield layer, after completing the magnetizing process, by forming the step-shaped sections, etc. in the shield layer or the base layer of the shield layer. Therefore, the planar shapes of the shield layers are not limited to the rectangular shapes.

The present invention may be applied to the lower shield layer and/or the upper shield layer. The present invention is characterized by the structure of the shield layer of the read-head of the magnetic head, so the read-element of the read-head is not limited. Further, the structure of the write-head of the magnetic head is not limited.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A magnetic head comprising a read-head, in which a read-element is magnetic-shielded by a shield layer,
wherein a step-shaped section is formed in a base layer, on which the shield layer is formed, and
said step-shaped section corresponds to a border of at least one of domain areas, which are defined by desired magnetic domains to be formed in the shield layer after a magnetizing process.

2. The magnetic head according to claim 1,
wherein a height of the domain area sectionalized by said step-shaped section is lower than that of other domain areas.

3. The magnetic head according to claim 1,
wherein a height of the domain area sectionalized by said step-shaped section is higher than that of other domain areas.

4. The magnetic head according to claim 1,
wherein a step pattern, which is separately formed from the base layer, is formed in the domain area sectionalized by said step-shaped section, and
a height of the step pattern is lower than that of other domain areas.

5. The magnetic head according to claim 1,
wherein a step pattern, which is separately formed from the base layer, is formed in the domain area sectionalized by said step-shaped section, and
a height of the step pattern is higher than that of other domain areas.

6. A magnetic head comprising a read-head, in which a read-element is magnetic-shielded by a shield layer,
wherein a step-shaped slit is formed in a base layer, on which the shield layer is formed, and
said step-shaped slit corresponds to a border of at least one of domain areas, which are defined by desired magnetic domains to be formed in the shield layer after a magnetizing process.

7. A magnetic head comprising a read-head, in which a read-element is magnetic-shielded by a shield layer,
wherein a step-shaped slit is formed in a surface of the shield layer, and
said step-shaped slit corresponds to a border of at least one of domain areas, which are defined by desired magnetic domains to be formed in the shield layer after a magnetizing process.

8. The magnetic head according to claim 7,
wherein a height of the domain area sectionalized by said step-shaped section is lower than that of other domain areas.

9. The magnetic head according to claim 7,
wherein a height of the domain area sectionalized by said step-shaped section is higher than that of other domain areas.

10. The magnetic head according to claim 1,
wherein the magnetic domains generated in the shield layer are asymmetrically arranged with respect to a height direction of the shield layer, and
area of the magnetic domain overlapping the read-element is maximized.

11. The magnetic head according to claim 6,
wherein the magnetic domains generated in the shield layer are asymmetrically arranged with respect to a height direction of the shield layer, and
area of the magnetic domain overlapping the read-element is maximized.

12. The magnetic head according to claim 7,
wherein the magnetic domains generated in the shield layer are asymmetrically arranged with respect to a height direction of the shield layer, and
area of the magnetic domain overlapping the read-element is maximized.
